(19) United States
(12) Patent Application Publication
(10) Pub. No.: US 2004/0089847 A1
(43) Pub. Date: May 13, 2004

(54) Stain solution which is devoid of phenol

(76) Inventors: Andreas Rauh, Darmstadt (DE); Daniela Grabis, Schwetzingen (DE); Evangelos Thomas, Darmstadt (DE); Dorothee Meier, Bochum (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/276,180

(22) PCT Filed: May 2, 2001
(86) PCT No.: PCT/EP01/04908

(30) Foreign Application Priority Data
May 18, 2000 (DE) 100 24 086.0

(51) Int. Cl. G01N 31/00

(52) U.S. Cl. 252/408.1

(57) ABSTRACT

The invention relates to a stain solution, which is devoid of phenol, for staining bacteria. Said solution contains at least one dye, one solvent and one of the following substances, or mixtures thereof, as a phenol substitute: 2-butoxy thylacetate, 2-phenylethanol, benzyl alcohol, 4-methoxyphenol or cyclohexanol.

The invention relates to phenol-free staining solutions for microbiology.

The identification of bacteria plays a major role in many areas, such as, for example, clinical diagnostics. It is frequently necessary to identify mycobacteria, which include, inter alia, the pathogen of tuberculosis, or Gram-negative or Gram-positive bacteria.

Bacteria can be differentiated on the basis of their different cell-wall composition. Thus, Gram-positive bacteria can be differentiated from Gram-negative bacteria and acid-resistant bacteria (in particular mycobacteria) can be differentiated from non-acid-resistant bacteria.

Acid-resistant mycobacteria are usually detected by Ziehl-Neelsen staining. The stain used here is fuchsin, which is available from Merck KGaA, Germany, as, for example, carbolfuchsin solution for hot staining or as Tb-color staining test for cold staining. An alternative staining method for studies using the fluorescence microscope is auramine-rhodamine solution for staining. An important constituent of all staining solutions is phenol. For example, a conventional fuchsin staining solution comprises about 5% of phenol. Without phenol, fuchsin staining of acid-resistant mycobacteria has hitherto been impossible.

Addition of phenol has likewise hitherto been essential for Gram staining. This staining serves to differentiate between Gram-positive and Gram-negative bacteria. In this staining, aniline stains (for example Crystal Violet) are bound to a stain/iodine complex in the bacterial cell wall on subsequent treatment with iodine. Gram-positive bacteria bind the complex in such a way that it cannot be re-detached, even on decolorisation with alcohol/acetone. The structure of the cell wall of these bacteria differs from that of acid-resistant mycobacteria. Phenol can therefore be employed in some-what smaller amounts (about 0.4%) for these stainings. Without the addition of phenol, however, the staining is incomplete and weak.

Phenol is toxic (poison class 2), caustic and suspected of being carcinogenic. Considerable safety precautions therefore have to be taken during the preparation and use of phenol-containing staining solutions. In addition, phenol has an unpleasant odour, which is usually still present in the end product and easily adheres to hands and clothes.

The object of the present invention was therefore to develop a staining solution for bacteria which comprises no phenol. The staining solution should have comparable staining properties to conventional phenol-containing solutions.

It has been found that phenol can be replaced in the staining reagents by 4-methoxyphenol, 2-phenylethanol, benzyl alcohol, 2-butoxyethyl acetate or cyclohexanol. The solutions exhibit staining results which are comparable, for example, with the sensitivity of conventional Ziehl-Neelsen staining. All phenol substitutes employed in accordance with the invention are significantly less toxic than phenol.

The present invention therefore relates to a phenol-free staining reagent for bacteria, at least comprising one or more stains, a solvent and one or more substances selected from 2-butoxyethyl acetate, 2-phenylethanol, benzyl alcohol, 4-methoxyphenol and cyclohexanol as phenol substitute.

In a preferred embodiment, the stain is an aniline stain.

In a preferred embodiment, the staining reagent is used for Ziehl-Neelsen staining.

In a preferred embodiment, the staining reagent according to the invention can be employed both for cold and hot Ziehl-Neelsen staining.

The staining reagent particularly preferably comprises 2-phenylethanol and/or benzyl alcohol.

The present invention also relates to the use of the staining solutions according to the invention for staining bacterial specimens.

The staining solutions according to the invention are suitable for staining bacteria on smears and cytological, histological, formalin-fixed and paraffin-mounted specimens, referred to below for the purposes of the invention as bacterial specimens.

The staining of bacteria can serve a variety of purposes. Firstly, germs can be stained so that they stand out from the background. It is possible to see their shape, i.e. whether they are, for example, rods or cocci. This can be achieved by any non-specific staining. Specific staining, such as, for example, Gram staining, Ziehl-Neelsen staining, etc., enables the bacteria to be pre-classified. Gram-positive bacteria can be differentiated from Gram-negative bacteria, and acid-resistant bacteria can be differentiated from non-acid-resistant bacteria. This staining result then enables the more precise species to be derived. Depending on their composition, the staining solutions according to the invention are suitable for non-specific or specific staining. The staining solutions according to the invention are particularly preferably employed for Ziehl-Neelsen staining of acid-resistant mycobacteria.

The staining solutions according to the invention typically consist of one or more stains, one or more solvents, one or more phenol substitutes and, if desired, further constituents, such as, for example, preservatives, acids, bases or salts. The stains used are stains which are also present in phenol-containing staining solutions in accordance with the prior art. These are preferably aniline stains, such as Methylene Blue, Crystal Violet or fuchsin. The solvents used are typically ethanol, water (preferably deionised) or other alcohols, such as, for example, isopropanol, or mixtures thereof. In accordance with the invention, the phenol in conventional staining solutions is replaced by a phenol substitute, such as 2-butoxyethyl acetate, 2-phenylethanol, benzyl alcohol, 4-methoxyphenol, cyclohexanol or mixtures thereof. In addition, the staining solutions may comprise further constituents as are also known for conventional staining solutions. The percentage of all constituents of the staining solutions typically corresponds approximately to that of known phenol-containing staining solutions, with phenol having been replaced in accordance with the invention by a phenol substi10 tute.

On use of cyclohexanol, it must be noted that this phenol substitute is only suitable for staining solutions which are not heated (as, for example, in hot staining), since cyclohexanol begins to burn, for example, under a naked flame.

It should furthermore be noted that germ-inhibiting preservatives additionally have to be added to some staining solutions since the germicidal action of the phenol is missing.

A staining solution according to the invention for general fuchsin staining typically comprises from 5 to 25% by volume, preferably from 10 to 20% by volume, of a saturated alcoholic fuchsin solution in water. The proportion of phenol substitute is between 0.3 and 10% by volume, preferably between 0.5 and 5% by volume.

A Ziehl-Neelsen staining is typically carried out using a staining solution comprising from 5 to 25% by volume, preferably from 10 to 20% by volume, of a saturated alcoholic fuchsin solution in ethanol/water. The proportion of phenol substitute is between 1 and 8%, preferably between 2 and 4%. The conventional HCl/ethanol solution typically used for decolorisation proved to be too strong on use of staining solutions according to the invention. For many applications, it was therefore diluted 1:1 with deionised water. The counterstaining is carried out, in accordance with the prior art, using a Malachite Green solution. Using the staining solutions according to the invention, the Ziehl-Neelsen staining can typically be carried out as hot or cold staining.

Auramine-rhodamine staining is generally carried out using a solution of isopropanol, glycerol, water and the two stains rhodamine B and auramine O. A staining solution comprising only rhodamine B does not require any phenol in order to develop its staining action. Since, however, the staining solution additionally comprises auramine 0, phenol or, in accordance with the invention, a phenol substitute, is required. The proportion of phenol substitute is typically between 6 and 12% by volume, preferably between 8 and 9%.

A Gram staining is typically carried out using a staining solution comprising from 5 to 25% by volume, preferably from 10 to 20% by volume, of a saturated alcoholic aniline stain solution (generally Crystal Violet) in ethanol/water. The proportion of phenol substitute is between 0.15 and 6%, preferably between 0.2 and 2%. The further steps of Gram staining are carried out using reagents in accordance with the prior art.

For all staining solutions, the proportion of the phenol substitute can be adjusted slightly depending on the substitute employed. For example, a Gram staining solution particularly preferably comprises from 0.2 to 0.5% of benzyl alcohol as phenol substitute, while from 0.8 to 1.5% is particularly preferably employed on use of 2-phenylethanol.

Staining methods with the phenol-free staining solutions according to the invention usually do not differ from the methods with conventional staining solutions. The person skilled in the art is able to modify, for example, contact times, washing times or solution concentrations correspondingly if necessary. Methods for staining microorganisms are described, for example, in Romeis, ‘Mikroskopische Technik’ [Microscope Technology], 17th Edition (1989).

For staining acid-resistant mycobacteria, the following method steps are typically carried out:

a) the bacterial specimens are covered with a staining solution according to the invention and incubated;

b) the staining solution is rinsed off using a solvent, usually water;

c) it is decolorised using decolorisation solution;

d) the bacterial specimens are incubated with a counterstaining solution;

e) the bacterial specimens are rinsed with a solvent, usually water, dried and optionally mounted.

The decolorisation solution employed in step c) is preferably a waterdiluted hydrochloric acid/ethanol solution.

The counterstaining solution employed in step d) is preferably a Malachite Green solution, for example with Malachite Green in the form of the oxalate, or a Methylene Blue solution.

A method corresponding to Ziehl-Neelsen staining is also carried out for staining with auramine-rhodamine.

The following method steps are typically carried out for Gram staining of bacteria:

a) the bacterial specimens are covered with a staining solution according to the invention and incubated, then rinsed briefly with, for example, water or preferably with Lugol's solution;

b) the bacterial specimens are then treated with an iodine-containing solution (Lugol's solution);

c) the specimens are rinsed with solvent, usually water;

d) decolorisation is carried out using a decolorisation solution comprising ethanol/acetone;

e) the bacterial specimens are optionally incubated with a counterstaining solution (for example safranine solution);

f) the bacterial specimens are rinsed with a solvent, dried and optionally mounted.

The staining solution in step a) preferably comprises Crystal Violet as stain.

The mounting of all bacterial specimens can be carried out, for example, using Entellan® from Merck KGaA.

The staining of bacterial specimens can generally be influenced by the concentration of the staining solutions. In general, better results are obtained if incubation is carried out for a longer time with a dilute solution. In the case of Ziehl-Neelsen staining, the staining can additionally be intensified by increasing the temperature during the staining, so-called hot staining. The classical Ziehl-Neelsen staining is therefore carried out as hot staining. The reagents according to the invention for Ziehl-Neelsen staining can preferably be employed both for classical hot staining and for cold staining.

The staining solutions according to the invention thus offer the opportunity to avoid the use of toxic phenol and achieve the same staining quality. The staining solutions according to the invention are just as easy to use as the solutions known from the prior art.

Even without further comments, it is assumed that a person skilled in the art will be able to utilise the above description in its broadest scope. The preferred embodiments and examples should therefore merely be regarded as descriptive disclosure which is absolutely not limiting in any way.

The complete disclosure content of all applications, patents and publications mentioned above and below, in particular of the corresponding application DE 100 24 086, filed on 18.05.2000, is incorporated into this application by way of reference.

### EXAMPLE

Ziehi-Neelsen Staining

Bacterial smears with Mycobacterium phlei, Mycobacterium fortuitum and Escherichia coli (as control) were stained. Furthermore, histological, formalin-fixed and paraffin-mounted specimens with Mycobacterium tuberculosis were employed. The smears were each prepared from bacteria from a culture.

The following reagents were employed:

Staining solution (per litre):

6.4 g of fuchsin (Cl 42510, Merck KGaA)

130 ml of ethanol (absolute)

846 ml of water (deionised)

24 ml of 2-phenylethanol dissolved in 40 ml of water

decolorisation solution: HCl (0.75%)/ethanol (hydrochloric acid/alcohol for microscopy, Merck KGaA). For use, this solution is diluted 1:1 with water.

Counterstaining solution: Malachite Green oxalate (Cl 42000, Tb-color solution, Merck KGaA)

Mounting medium: Entellan® (Merck KGaA)

The bacterial specimens are covered with the staining solution. After a contact time of 5 minutes, they are rinsed briefly with tap water. After brief dripping off, the decolorisation is carried out with the decolorisation solution.

Since the conventional decolorisation solution decolorises too aggressively, it was diluted 1:1 with water. The decolorisation is complete when colour clouds no longer dissolve out of the specimen (after about 5 seconds). The specimens are then immediately rinsed with tap water and substantially dried. Counterstaining is subsequently carried out with Malachite Green solution (contact time 1-2 minutes). The specimens are again rinsed with tap water, then dried and mounted using a cover slip and Entellan®.

The ready-stained and mounted specimens can be studied under a light microscope. The acid-resistant mycobacteria are stained a luminescent red, whereas the E. coli are pale green.

The assessment criteria for the quality of the staining are as follows:

a) the intensity/contrast of the stained bacteria

b) the percentage of stained bacteria.

Both in hot and cold staining, the staining solution according to the invention exhibits a staining quality which corresponds to the staining quality of phenol-containing staining solutions.

1. Phenol-free staining solution for bacteria, at least comprising a stain, a solvent and one of the substances 2-butoxyethyl acetate, 2-phenylethanol, benzyl alcohol, 4-methoxyphenol or cyclohexanol or mixtures thereof as phenol substitute.

2. Phenol-free staining solution according to claim 1, characterised in that the stain is an aniline stain.

3. Use of a staining solution according to one of claims 1 and 2 for staining bacterial specimens.
